(19) United States
(12) Patent Application Publication
(10) Pub. No.: US 2002/0095791 A1
(43) Pub. Date: Jul. 25, 2002

(54) Razor blade cartridge having guard ribs and methods therefor

(76) Inventors: Andrew J. Pennella, Stamford, CT (US); Paul D. Richard, Shelton, CT (US); David F. Rivers, Wallingford, CT (US)

Correspondence Address: Gregg C. Benson, Pfizer Inc., Patent Department, MS 4159, Eastern Point Road, Groton, CT, 06340, US

(21) Appl. No.: 09/767,627

(22) Filed: Jan. 23, 2001

(51) Int. Cl. B26B 21/14

(52) U.S. Cl. 30/50

(57) ABSTRACT

A razor blade cartridge includes a plastic body having a leading edge, a trailing edge, and a series of guard ribs integrally molded with the plastic body and extending between the leading and trailing edges of the plastic body. The razor blade cartridge also includes one or more cutting blades encompassed by the plastic body, each of the cutting blades including a cutting edge facing the leading edge of the plastic body. The guard ribs, which cover the cutting edges of the cutting blades, reduce friction as the cutting blades pass over a skin surface and minimize the likelihood of nicks and cuts while shaving.

### BACKGROUND OF THE INVENTION

The present invention is directed to razor blade cartridges for razors and is particularly directed to razor blade cartridges having protective guard ribs that are integrally connected to the cartridge body, whereby the guard ribs cover the cutting edges of the cutting blades.

There are a wide variety of safety razors that are well-known to those skilled in the art. Typically, a safety razor includes a handle and a razor blade cartridge attached to an upper end of the handle. The razor blade cartridge, which can typically include one, two, three (or more) cutting blades fixedly embedded in the cartridge, may be integrally formed with the handle as a molded plastic part or may be a separate item attachable to the handle.

European Patent document EP 0389007 discloses a razor blade cartridge including a wire having a number of adjacent windings wound around a plastic cartridge body and having two razor blades embedded in the plastic body. The respective wire windings are spaced from one another and extend in directions parallel to the direction of shaving. The protective wire windings are intended to improve the shaving characteristics of the razor blade cartridge by preventing the formation of folds or bulges of the skin, thereby minimizing the likelihood of cuts and/or nicks to the skin. In addition, the wire windings reduce shaving resistance by reducing frictional forces, and help to prevent to occurrence of accidental cuts during improper handling of a razor.

U.S. Pat. No. 5,359,774 to Althaus discloses a razor blade cartridge including a plastic body having cutting blades embedded therein. The plastic body has a top cover and a front guardbar that define surface points for engaging the skin of a user. The guardbar, a spacer, and the top cover all have comb-like projections that are aligned with each other and provide protection to the skin. During shaving, the skin has a tendency to form bulges and folds which can cause these parts to be excessively exposed to the cutting edges of the blades. The comb-like projections prevent this from occurring and also provide an additional friction reducing effect to the razor head, thereby providing a comfortable and safe shave.

U.S. Pat. No. 4,272,885 to Ferraro discloses a shaving cartridge including a blade seat, a seat blade, a cap blade, a cap and a spacer between the blades, whereby the blades are exposed for shaving. The spacer is provided with a series of projections, at least some of which extend beyond the cutting edges of the blades for diminishing the contact between the blades and the skin so as to minimize the possibility for nicks and cuts of the skin and to produce improved shaving comfort.

International Publication No. WO 99/52688 discloses a blade cartridge including one or more blades fixed between a platform and a cap. The cartridge includes one or more ribs positioned proximate the cutting edges of the blades so that a portion of the blades adjacent the ribs has a negative exposure. The guard ribs are generally evenly positioned along the razor blade cartridge. The cartridge also includes guard ribs on the cap member that are aligned with and substantially continuous with the guard ribs on the platform. The guard ribs provide the portions of the skin engaging edges with a negative blade exposure that prevents overexposure of the blades to the skin, while allowing the remainder of the skin engaging edges of the blade to provide a close shave.

Other methods for providing safety features on razor blade include taped blades and foil guarded cartridges. Taped blades typically include a sheet of material extending from the upper surface of the blade, over the blade edge, to the lower surface of the blade. The sheet of material typically has openings that are aligned with the cutting edge of the blade so as to allow the cutting edge to contact the skin of a user. Foil guarded razor blade cartridges are generally assembled with a piece of foil extending over a cap member, the cutting blades and a platform member. The foil has openings aligned with the cutting edges of the cutting blade so as to allow the cutting edges to contact the skin of a user.

Although the above-mentioned features provide some measure of safety, there are a number of problems associated with these features. For example, the expense associated with making such razor blade cartridges can be extremely high due to the relatively complex mechanism needed to produce wire wrapped, taped and foil guarded razor blade cartridges. Moreover, wire wrapped, foil guarded and taped razor blade cartridges tend to grab or pull a user's whiskers as the whiskers become caught between the protective member and the blades. Such assemblies also tend to collect debris and other materials between the protective member and the blades. Moreover, foil guarded, taped and wire wrapped cartridges limit the closeness of a shave that may be obtained using such a device. Wire wrapped razor blade cartridges have the further disadvantaged that the wire tends to embed itself into the cutting edge of the blade thereby damaging the blade. Additionally, the wires are easily moved from their initial location during use, thereby altering the shaving characteristics of the blade and potentially causing excess wear on the cutting edges thereof.

In view of the above, it is clear that there is a need for a razor blade cartridge having guard ribs that is easy and inexpensive to manufacture, and that provides a safe and comfortable shave.

### SUMMARY OF THE INVENTION

In accordance with certain preferred embodiments of the present invention, a razor blade cartridge includes a plastic body having a leading edge, a trailing edge and a series of guard ribs integrally molded with the plastic body and extending between the leading and trailing edges of the plastic body. In certain preferred embodiments, the guard ribs are spaced apart from one another, and in particularly preferred embodiments, the guard ribs are evenly spaced from one another. The razor blade cartridge also preferably includes one or more cutting blades encompassed by the plastic body, each of the cutting blades including a cutting edge facing the leading edge of the plastic body. The one or more guard ribs desirably cover one or more sections of a cutting edge of at least one of the cutting blades. In other words, at least one of the guard ribs preferably overlie the cutting edge of at least one of the cutting blades so that the at least one guard rib projects beyond the cutting edge of at least on the cutting blades. The guard ribs are preferably formed substantially simultaneously with the plastic body and are preferably made of the same material (e.g. plastic) as the plastic body.

In certain preferred embodiments, the one or more cutting blades preferably include two or three cutting blades that are substantially parallel to one another and to the leading and trailing edges of the plastic body. In certain embodiments, the guard ribs are substantially perpendicular to the one or more cutting blades. In other words, the ribs are substantially parallel to the shaving direction of the razor blade cartridge.

In certain preferred embodiments, the guard ribs have substantially uniform dimensions. In other words, the guard ribs have an overall shape, size, length, height, and/or thickness that is substantially uniform. However, in other preferred embodiments, the guard ribs may have non-uniform dimensions. In one particular embodiment, the guard ribs include a center guard rib and at least one pair of guard ribs on opposing sides of the center guard ribs. In these embodiments, the center guard rib may have a first dimension and a pair of outer guard ribs may have a second dimension that is smaller than the dimension of the center guard rib. The center guard rib may have a front edge having a length that is greater than the front edges of the outer guard ribs. In other embodiments, the center guard rib may have a height that is greater than the height of the outer guard ribs. The series of guard ribs may also include a pair of intermediate guard ribs disposed between the center guard rib and the outer guard ribs. The intermediate guard ribs have a dimension that is smaller than the first dimension of the center guard rib.

In other preferred embodiments, the intermediate guard ribs have a dimension that is greater than the second dimension of the outer guard ribs. The intermediate guard ribs desirably have a length or a height that is greater than the length or height of the outer guard ribs. In still other embodiments, the series of guard ribs include a center guard rib having a first length and a pair of intermediate guard ribs on opposing sides of the center guard rib, the pair of intermediate guards having a length that is less than the first length of the center guard rib. As used herein, the term “length” means the length of the front edge of a guard rib, whereby the front edge of a guard rib overlies or covers at least a section of a cutting edge. The guard ribs may also include a pair of outer guard ribs on opposing sides of the intermediate guard ribs, wherein the outer guard ribs have a length that is less than the length of the intermediate guard ribs. In particularly preferred embodiments, the razor blade cartridge includes a center guard rib with two pairs of guard ribs on opposing sides of the center guard rib. However, other preferred embodiments may include three, four, five or more pairs of guard ribs extending along the length of the cutting blades.

In accordance with still other preferred embodiments of the present invention, a method of making a razor blade cartridge includes providing a mold for making a razor blade cartridge and securing at least one cutting blade, and preferably two or more cutting blades having a cutting edge in the mold. A moldable plastic material is then introduced into the mold so as to form a plastic cartridge body that encompasses the at least one cutting blade. The plastic cartridge body desirably includes a leading edge, a trailing edge and a series of guard ribs integrally molded with the plastic body and extending between the leading and trailing edges thereof. The guard ribs and the plastic body are desirably formed substantially simultaneously with one another so that the ribs are integrally connected with the plastic body. The least one cutting blade preferably includes a cutting edge facing toward the leading edge of plastic body, whereby one or more of the guard ribs cover or overlie the cutting edge of least one cutting blade. In certain preferred embodiments, the step of securing at least one cutting blade includes securing three cutting blades in the mold so that the three cutting blades are substantially parallel to one another, whereby the cutting edges of the cutting blades face in the same direction and the guard ribs overlie the cutting edges of the cutting blades. In yet further preferred embodiments, the razor blade cartridge also includes a guardbar secured to the leading edge of the plastic cartridge body. The guardbar is preferably made of a compliant polymer material and may include a series of wells formed at a top surface thereof. Each well may include a centrally located projection. The guardbar preferably engages the skin of a user for stretching the user's skin. The wells and projections may serve to smooth a lubricant on a user's skin. During a shaving operation, the wells may pick up and store small quantities flubricant that is later applied to a skin surface during a subsequent shaving stroke.

These and other preferred embodiments of the present invention will be described in more detail below.

### BRIEF DESCRIPTION OF THE DRAWINGS

FIG. 1 shows a perspective view of a razor blade cartridge including guard ribs, in accordance with certain preferred embodiments of the present invention.

FIG. 2 shows another perspective view of the razor blade cartridge shown in FIG. 1.

FIG. 3 shows an enlarged fragmentary view of a section of the razor blade cartridge shown in FIGS. 1 and 2.

FIG. 4 shows a perspective view of a razor blade cartridge having guard ribs, in accordance with other preferred embodiments of the present invention.

FIG. 5 shows a perspective view of a razor blade cartridge including guard ribs, in accordance with yet further preferred embodiments of the present invention.

FIG. 6 shows a perspective view of a razor blade cartridge including guard ribs, in accordance with still further preferred embodiments of the present invention.

### DETAILED DESCRIPTION OF PREFERRED EMBODIMENTS

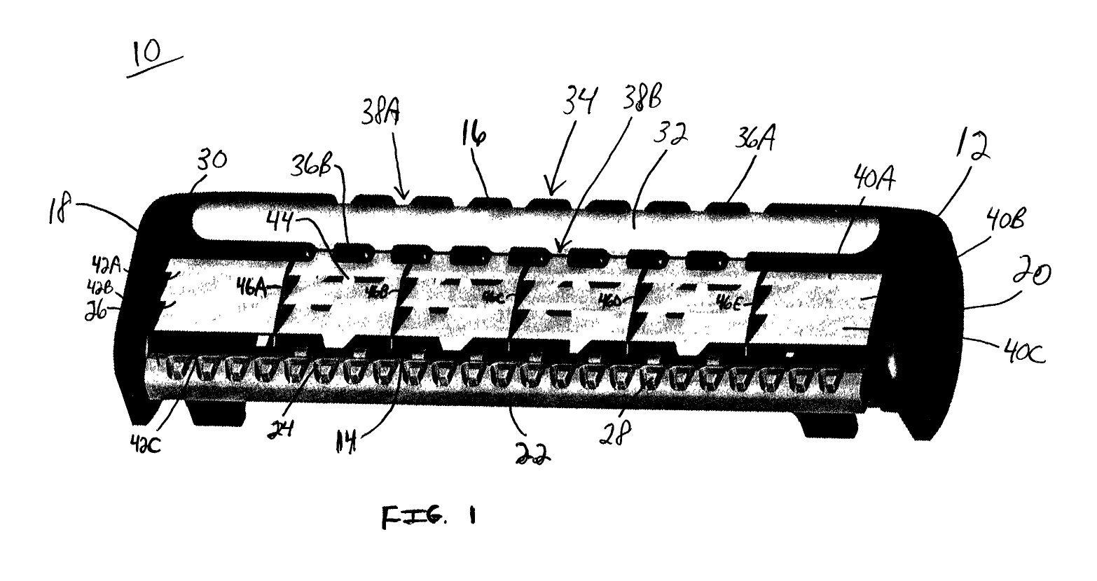

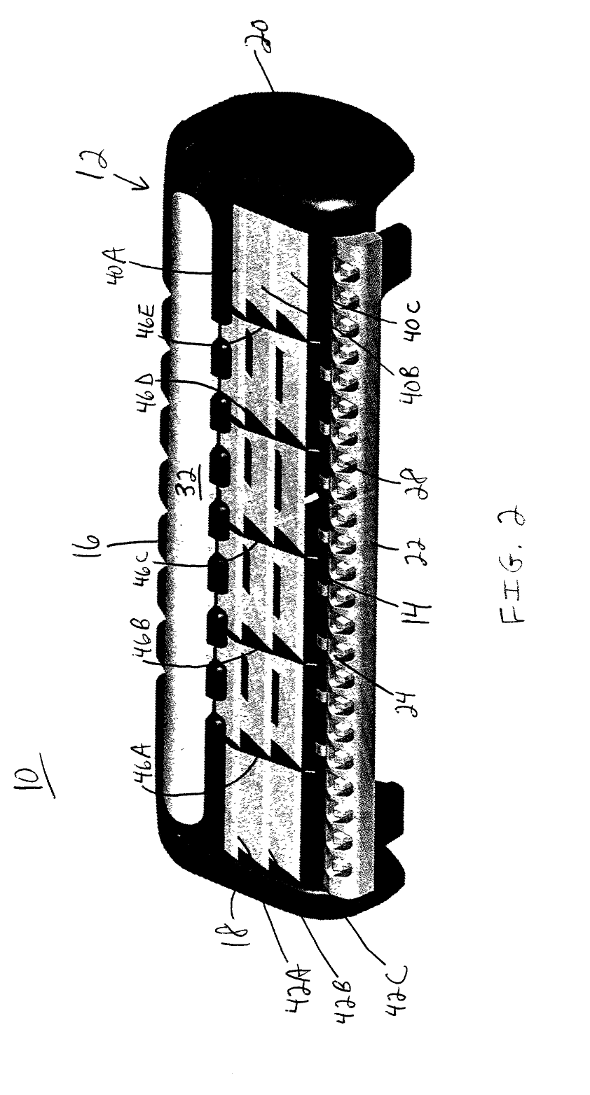

Referring to FIGS. 1 and 2, a razor blade cartridge includes a plastic body 12 having a leading edge 14 and a trailing edge 16. The plastic body 12 also includes a first end 18 and a second end 20, the first and second ends being integrally formed with plastic body 12. The body 12 is preferably made of a hard moldable material. Razor blade cartridge 10 includes a guardbar 22 attached to the leading edge 14 of the plastic body 12. Guardbar 22, preferably made of a compliant material, includes a series of wells 24 formed in an upper surface 26 thereof. Each well 24 preferably includes a bump or projection 28 centered therein. In certain preferred embodiments, the wells 24 may be substantially trapizoidal in shape. Razor blade cartridge 10 also preferably includes a cap 30 integrally formed with plastic body 12 and located adjacent the trailing edge 16 thereof. A lubricating strip 32 may be secured over cap 30 so as to provide a lubricant to a user's skin when lubricating strip 32 contacts a liquid such as water. An intermediate section 34 of cap 30 includes an array of bumps 36A, 36B having associated gaps 38A, 38B therebetween. The gaps 38A, 38B provide flexibility for the plastic body 12 so that the first and second ends 18, 20 of the plastic body 12 may flex and bend relative to one another.

In the particular preferred embodiment shown in FIGS. 1 and 2, razor blade cartridge 10 includes three cutting blades 40A, 40B, 40C having respective cutting edges 42A, 42B, 42C. Cutting blades 40A-40C are molded into plastic body 12 and are preferably substantially parallel to one another. The cutting edges 42A-42C of cutting blades 40A-40C preferably face the leading edge 14 of plastic body 12. One or more of the cutting blades 40A-40C preferably includes openings 44 extending therethrough so that water and debris may readily flow or be removed from between the cutting blades.

Razor blade cartridge 10 also preferably includes a series of guard ribs 46A-46E integrally molded with plastic body 12. The guard ribs include a center guard rib 46C, a pair of outer guard ribs 46A and 46E, and a pair of intermediate guard ribs 46B and 46D. The guard ribs 46A-46E are preferably uniform in their dimension, i.e., size, shape, height, length and thickness. In particularly preferred embodiments, the guard ribs 46A-46E are formed simultaneously with the plastic body 12 as a whole. As a result, there is no need for secondary operations, special machinery, additional parts or WIP. The guard ribs are preferably made of the same material used to make the plastic body 12.

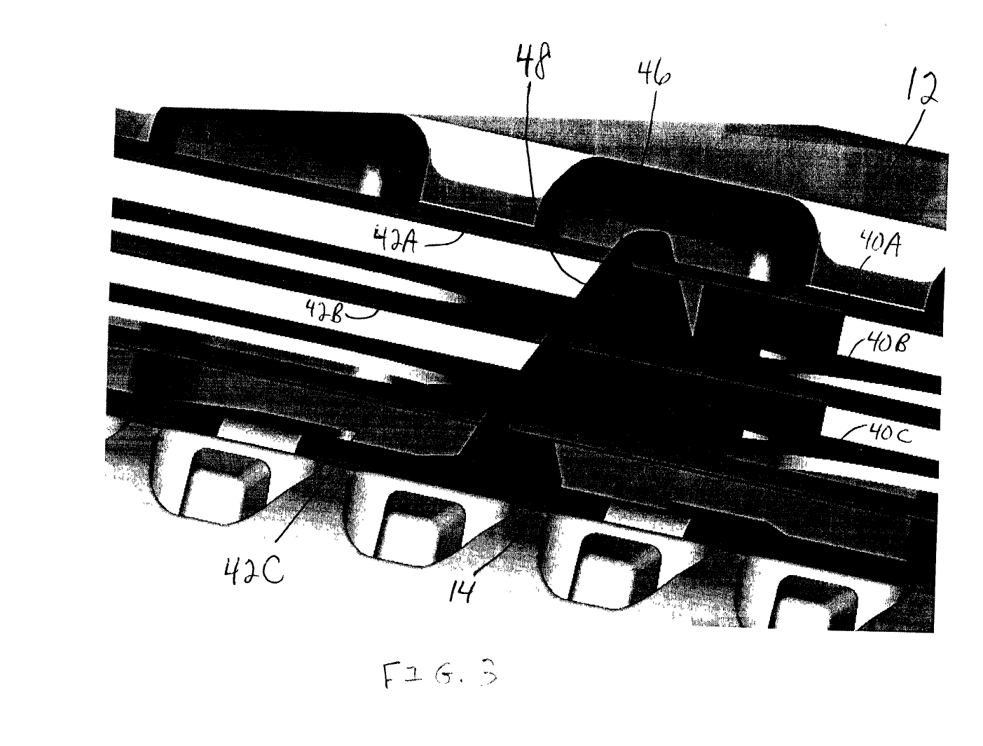

Referring to FIG. 3, in certain preferred embodiments, each guard rib 46 has a front edge 48 that covers and overlies a portion of the cutting edges 42A-42C of cutting blades 40A-40C. As a result, the guard rib 48 extends between the leading edge 14 and trailing edge (not shown) of plastic body 12. Guard rib 48 projects above, covers and/or overlies the cutting edges 42A-42C of cutting blades 40A-40C so as to minimize the possibility of a user nicking or cutting a skin surface during a shaving operation. The front edge 48 of guard rib 46 extends between the leading edge 14 and trail edge of the plastic body so as to reduce the amount of friction or drag as the razor blade cartridge is dragged across a skin surface. In the particular embodiment shown in FIGS. 1-2, the guard ribs 46A-46E have a substantially uniform dimension. In other words, each of the guard ribs has substantially the same shape, height, length and width.

In certain preferred embodiments, the razor blade cartridge 10 shown in FIGS. 1-3 is manufactured by providing a thermoplastic mold and then securing at least one cutting blade having a cutting edge inside the mold. In the particular preferred embodiments shown in FIGS. 1-3, at least three cutting blades are secured inside a thermoplastic mold, the cutting blades being substantially parallel to one another with the cutting edges facing in the same direction. The plastic body of the razor blade cartridges is then formed by injecting a heated plastic material into the mold. The plastic material is then cured to provide the plastic body, whereby the cutting blades are encompassed or surrounded by the plastic material. In particular preferred embodiments, the guard ribs are an integral portion of the plastic body and overlie at least a portion of the cutting edges of the cutting blades.

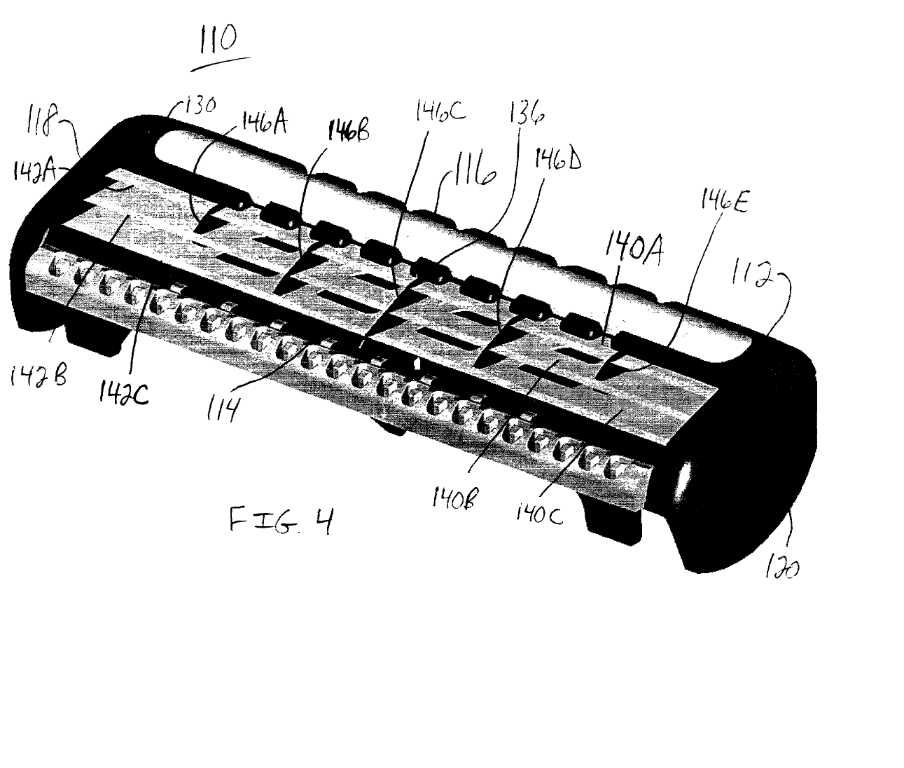

FIG. 4 shows a razor blade cartridge 110 in accordance with another preferred embodiment of the present invention including plastic body 112 having leading edge 114 and trailing edge 116. Razor blade cartridge 110 includes three cutting blades 140A-140C extending between integrally connected ends 118, 120. Cutting blades 140A, 140C are substantially parallel to one another and have cutting edges 142A-142C that face the leading edge 114 of plastic body 112. Razor blade cartridge 110 includes a series of guard ribs 146A-146E that extend between leading edge 114 and trailing edge 116 and are integrally molded with plastic body 112. The guard ribs include a center guard rib 146, a pair of outer guard ribs 146A and 146E on opposing sides of the center guard rib 146C, and a pair of intermediate guard ribs 146B and 146D on opposing sides of the center guard rib 146C and between the outer guard ribs 146A, 146E and center guard rib 146C. In a particular preferred embodiment shown in FIG. 4, the guard ribs are non-uniform in their dimension. As used herein, the term “dimension” may mean the overall shape, length, height, width or thickness of a guard rib. As shown in FIG. 4, center guard rib 146 has a first dimension and a pair of outer guard ribs 146A, 146E have a second dimension that is smaller than the first dimension of the center guard rib 146C. Specifically, the center guard rib 146c extends the entire distance between leading edge 114 and a bump 136 integrally connected to cap 130. Moreover, center guard rib 146C overlies the cutting edges 142A-142C of all three cutting blades, 140A-140C. In contrast, the pair of outer guard ribs 146A-146E extend only partway between cap 130 and leading edge 114. As such, the outer guard ribs 146A-146E only cover the cutting edge 142A of the uppermost cutting blade 140A. In addition, the pair of intermediate guard ribs 146B, 146D have a dimension that is greater than the dimension of the outer guard rib 146A, 146E but less than the dimension of center guard rib 146C. As a result, the intermediate guard ribs 146B, 146D only cover the cutting edges 142A and 142B of the upper two cutting blades 140A, 140B.

Although the present invention is not limited by any particular theory of operation, it is believed that more force is exerted on the razor blade cartridge in the vicinity of the center guard rib 146E than in the vicinity of the intermediate guard ribs 146B, 146D or outer guard ribs 146A, 146E. As such, the front edge 148C of center guard rib 146C is longer than the front edges of the other guard ribs so as to minimize friction forces due to drag as the cutting blades pass over a skin surface.

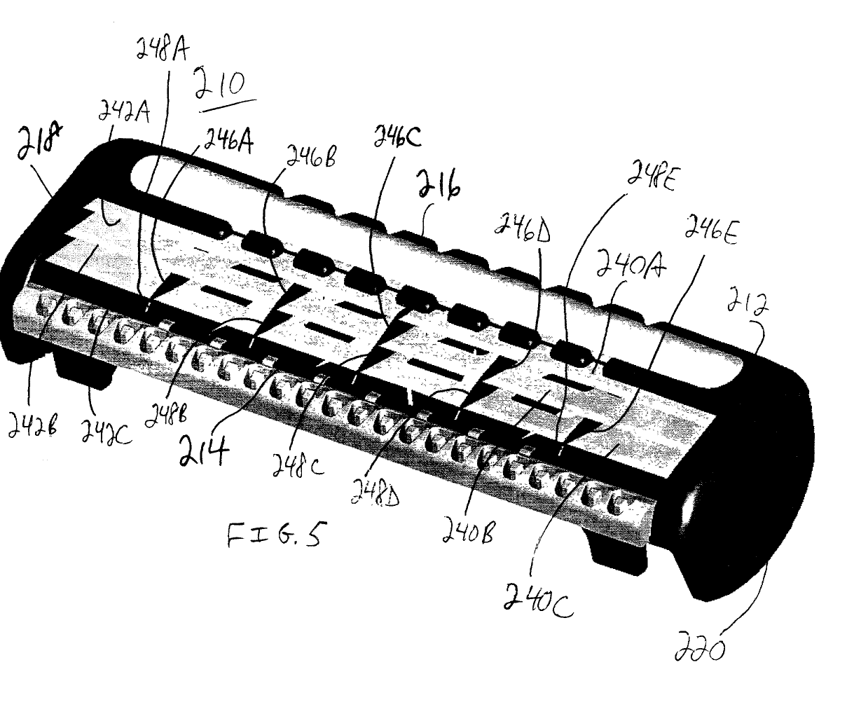

FIG. 5 shows a razor blade cartridge 210 in accordance with another preferred embodiment of the present invention. Razor blade cartridge 210 includes a plastic body 212 having a leading edge 214 and a trailing edge 216. A set of three cutting blades 240A-240C are embedded in the plastic body 212. The cutting blades 240A-240C are preferably substantially parallel to one another and extend between the opposing ends 218, 220 of plastic body 212. Razor blade cartridge 210 also includes a series of guard ribs 246A-246E that are integrally molded with the plastic body 212. The guard ribs comprise a molded plastic that in integrally connected to the plastic body 212. In the particular preferred embodiment shown in FIG. 5, the guard ribs 246A-246E are non-uniform in dimension. Specifically, the center guard rib 246A has a greater dimension than intermediate guard ribs 246B, 246D which, in turn, have a greater dimension than outer guard ribs 246A, 246E. As shown in FIG. 5, the front edge 248C of center guard rib 246C overlies the cutting edges 242A-242C of all three cutting blades 240A-240C. In contrast, the intermediate guard blades 242B, 242D have front edges 248A, 248D that only cover the cutting edges 242B, 242C of the lower two cutting blades 240B, 240C. The pair of outer guard ribs 246A, 246E have front edges 248A, 248E that cover the cutting edge 242C of the lowermost cutting blade 240C.

Although the present invention is not limited to any particular theory of operation, it is believed that providing a center guard rib 246 having a longer front edge 248C than the intermediate or outer guard ribs will minimize resistance or drag as the cutting edges of the cutting blades are drawn across a skin surface. The front edges of the intermediate and outer guard ribs is not required to be as long as the front edge of the center guard rib as less force is applied in these areas.

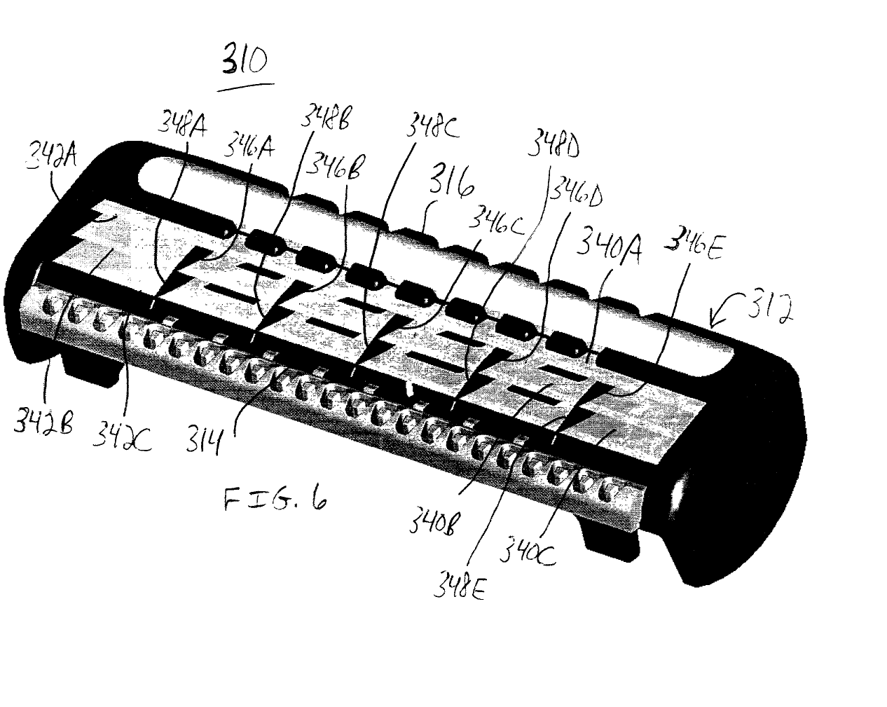

FIG. 6 shows a razor blade cartridge 310 in accordance with yet another preferred embodiment of the present invention. Razor blade cartridge 310 includes plastic body 312 having leading edge 314 and trailing edge 316. The razor blade cartridge 310 also includes a series of guard ribs 346A-346E that are integrally molded with plastic body 312. Each guard rib includes a respective front edge 348A-348E associated therewith. In the particular preferred embodiment shown in FIG. 6, the front edges 348A-348E of the guard ribs have substantially the same length so that the guard ribs are substantially uniform in dimension. As a result, the guard ribs cover or overlie sections of the cutting edges 342B, 342C of the two lowermost cutting blades 340B, 340C. In this embodiment, the cutting edge 342A of the uppermost cutting blade 340A is completely exposed and is not covered by one of the guard ribs.

These and other variations and combinations of the features described above may be utilized without departing from the present invention as defined by the claims. For example, any number of guard ribs may be integrally formed with the plastic cartridge body. The number of guard ribs may also be an even number. Thus, the foregoing description of preferred embodiments should be taken by way of illustration rather than by way of limitation of the claimed invention.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A razor blade cartridge comprising:
a plastic body including a leading edge, a trailing edge, and a series of guard ribs integrally molded with said plastic body and extending between the leading and trailing edges thereof; and
one or more cutting blades encompassed by said plastic body, each said cutting blade including a cutting edge facing the leading edge of said plastic body, wherein one or more of said guard ribs cover the cutting edge of at least one of said cutting blades.

2. The cartridge as claimed in claim 1, wherein said guard ribs are spaced apart from one another.

3. The cartridge as claimed in claim 1, wherein said guard ribs are evenly spaced apart from one another.

4. The cartridge as claimed in claim 1, wherein said guard ribs overlie the cutting edge of at least one of said cutting blades.

5. The cartridge as claimed in claim 1, wherein said guard ribs project beyond the cutting edge of at least one of said cutting blades.

6. The cartridge as claimed in claim 1, further comprising a guard bar at the leading edge of said plastic body.

7. The cartridge as claimed in claim 6, wherein said guard bar comprises a series of depressions formed at an upper surface thereof.

8. The cartridge as claimed in claim 7, wherein each said depression in said guard bar includes a projection substantially centered therein.

9. The cartridge as claimed in claim 1, further comprising a cap at the trailing edge of said plastic body.

10. The cartridge as claimed in claim 9, further comprising a lubricating strip attached to said cap.

11. The cartridge as claimed in claim 1, wherein said one or more cutting blades are substantially parallel to one another and to the leading and trailing edges of said plastic body.

12. The cartridge as claimed in claim 11, wherein said guard ribs are substantially perpendicular to said one or more cutting blades.

13. The cartridge as claimed in claim 1, wherein said guard ribs have non-uniform dimensions.

14. The cartridge as claimed in claim 1, wherein said guard ribs have uniform dimensions.

15. The cartridge as claimed in claim 1, wherein said guard ribs comprise a center guard rib and at least one pair of guard ribs on opposing sides of said center guard rib.

16. The cartridge as claimed in claim 1, wherein said guard ribs comprise a center guard rib having a first dimension and a pair of outer guard ribs having a second dimension that is smaller than the center guard rib.

17. The cartridge as claimed in claim 16, wherein the center guard rib has a length that is greater than the length of the outer guard ribs.

18. The cartridge as claimed in claim 17, wherein the center guard rib has a height that is greater than the height of the outer guard ribs.

19. The cartridge as claimed in claim 16, wherein said guard ribs further comprise a pair of intermediate guard ribs disposed between the center guard rib and the outer guard ribs, and wherein the intermediate guard ribs have a dimension that is smaller than the first dimension of the center guard rib.

20. The cartridge as claimed in claim 19, wherein the intermediate guard ribs have a dimension that is greater than the second dimension of the outer guard ribs.

21. The cartridge as claimed in claim 20, wherein the intermediate guard ribs have a length that is greater than the length of the outer guard ribs.

22. The cartridge as claimed in claim 21, wherein the intermediate guard ribs have a height that is greater than the height of the outer guard ribs.

23. The cartridge as claimed in claim 1, wherein said series of guard ribs comprise a center guard rib having a first length and a pair of intermediate guard ribs on opposing sides of said center guard rib, said pair of intermediate guard ribs having a length that is less than the first length of said center guard rib.

24. The cartridge as claimed in claim 23, wherein said guard ribs further comprise a pair of outer guard ribs on opposing sides of said intermediate guard ribs, and wherein said outer guard ribs have a length that is less than the length of said intermediate guard ribs.

25. A razor blade cartridge comprising:
a cartridge body including a leading edge, a trailing edge, and a series of guard ribs integrally connected with said cartridge body and extending between the leading and trailing edges thereof; and
cutting blades disposed in said cartridge body, said cutting blades being substantially parallel to one another, each said cutting blade including a cutting edge facing the leading edge of said cartridge body, wherein said guard ribs at least partially cover the cutting edges of said cutting blades.

26. The cartridge as claimed in claim 25, wherein said guard ribs are evenly spaced apart from one another.

27. The cartridge as claimed in claim 25, wherein said cutting blades extend in a direction substantially perpendicular to said guard ribs.

28. The cartridge as claimed in claim 25, wherein said guard ribs comprise a center guard rib and a pair of outer guard ribs on opposing sides of said center guard rib.

29. The cartridge as claimed in claim 28, further comprising a pair of intermediate guard ribs on opposing sides of said center guard rib, wherein said intermediate guard ribs are disposed between said center guard rib and said outer guard ribs.

30. The cartridge as claimed in claim 25, wherein said guard ribs have a substantially uniform dimension.

31. The cartridge as claimed in claim 25, wherein said guard ribs have a substantially non-uniform dimension.

32. The cartridge as claimed in claim 31, wherein said center guard rib has a first dimension and said pair of outer guard ribs have a second dimension that is smaller than the first dimension of said center guard rib.

33. The cartridge as claimed in claim 32, wherein said pair of intermediate guard ribs have a dimension that is smaller than the first dimension of said center guard rib.

34. The cartridge as claimed in claim 33, wherein the dimension of said pair of intermediate guard ribs is larger than the second dimension of said outer guard ribs.

35. A method of making a razor blade cartridge comprising:
providing a mold for making a razor blade cartridge;
securing at least one cutting blade having a cutting edge in the mold;
introducing a moldable plastic material into said mold to form a plastic cartridge body encompassing said at least one cutting blade, wherein said plastic cartridge body includes a leading edge, a trailing edge, and a series of guard ribs integrally molded with said plastic body and extending between the leading and trailing edges thereof, wherein said at least one cutting blade includes a cutting edge facing toward the leading edge of said plastic body, and wherein one or more of said guard ribs cover the cutting edge of said at least one cutting blade.

36. The method as claimed in claim 35, wherein said guard ribs and said plastic body are formed substantially simultaneously in the mold.

37. The method as claimed in claim 35, wherein the step of securing at least one cutting blade includes securing three cutting blades in said mold so that said three cutting blades are substantially parallel to one another, and wherein the cutting edges of said cutting blades face in the same direction.

38. The method as claimed in claim 37, wherein said guard ribs overlie the cutting edge of said at least one cutting blade.

39. The method as claimed in claim 37, wherein said guard ribs project beyond the cutting edge of said at least one cutting blade.

40. The method as claimed in claim 35, further comprising securing a guard bar to the leading edge of said plastic cartridge body.
